(19) United States
(12) Patent Application Publication
(10) Pub. No.: US 2013/0057572 A1
(43) Pub. Date: Mar. 7, 2013

(54) Multiple Display Device Taskbars

(71) Applicants: Bret P. Anderson, Kirkland, WA (US); Tsz Yan Wong, Seattle, WA (US); Wei-Ting Hsiao, Bellevue, WA (US)

(72) Inventors: Bret P. Anderson, Kirkland, WA (US); Tsz Yan Wong, Seattle, WA (US); Wei-Ting Hsiao, Bellevue, WA (US)

(73) Assignee: Microsoft Corporation, Redmond, WA (US)

(21) Appl. No.: 13/227,084

(22) Filed: Sep. 7, 2011

(51) Int. Cl. G09G 5/00

(52) U.S. Cl. 345/619

(57) ABSTRACT

Multiple display device taskbars are described. A system is described that includes at least one or more modules implemented at least partially in hardware. The one or more modules are operable to configure a display environment of a computing device to display a first taskbar for display on a first display device of the display environment, the first taskbar configured to include a representation of a plurality of applications that are executed by the computing device. The one or more modules are also operable to configure a second taskbar for display on a second display device of the display environment, the second taskbar configured to include a representation of at least one application that corresponds to a user interface configured for output on the second display device and does not include a representation of another application that corresponds to a user interface configured for output on the first display device.

### BACKGROUND

Users have access to an ever increasing functionality that may be provided by computing devices. From browsers to word processors, spreadsheets, calendaring and email applications, and so on, a user may execute a wide number of applications at any one time to view information from these applications.

In order to increase the amount of information that is viewable at a particular time, a user may employ a plurality of display devices (e.g., monitors) that are communicatively coupled to a single computing device. In this way, a user increases an amount of area that is available to display data from the applications that are executed on the computing device. However, this increase in display area could also negatively affect traditional techniques for user interaction that were generally based on a single display device.

### SUMMARY

Multiple display device taskbars are described. In one or more implementations, a system includes at least one or more modules implemented at least partially in hardware. The one or more modules are operable to configure a display environment of a computing device to display a first taskbar for display on a first display device of the display environment. The first taskbar is configured to include a representation of a plurality of applications that are executed by the computing device. The one or more modules are also operable to configure a second taskbar for display on a second display device of the display environment, the second taskbar configured to include a representation of at least one application that corresponds to a user interface configured for output on the second display device and does not include a representation of another application that corresponds to a user interface configured for output on the first display device.

In one or more implementations, a first taskbar is displayed on a first display device of a computing device, the first taskbar including a representation of a first application that is executed on the computing device that corresponds to a first user interface that is to be positioned for display on the first display device. A second taskbar is displayed on a second display device of the computing device, the second taskbar including a representation of the first application and a representation of a second application that is executed on the computing device that corresponds to a second user interface that is to be positioned for display on the second display device.

In one or more implementations, one or more computer readable storage media comprise instructions stored thereon that, in response to execution by a computing device, cause the computing device to configure a display environment of an operating system executed by the computing device. The display environment is configured to include a primary taskbar for display on a primary display device of the display environment, the primary taskbar configured to include a representation of each application that is being executed by the computing device. The display environment is also configured to include a secondary taskbar for display on a secondary display device of the display environment, the secondary taskbar configured to include a representation for each application that is executed on the computing device having a corresponding window that is positioned for display on the secondary display device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to implement the display environment techniques that involve a plurality of display devices as described herein.

FIG. 2 is an illustration of a system in an example implementation of a computing device of FIG. 1 as employing a plurality of display devices and a primary taskbar.

FIG. 3 is an illustration of a system in an example implementation of a computing device of FIG. 1 as employing a plurality of display devices and a secondary taskbar.

FIG. 4 is an illustration of a system in an example implementation of a computing device of FIG. 3 as outputting a user interface corresponding to a social network application in response to selection of a representation in a secondary taskbar of FIG. 3

FIG. 5 is a flow diagram depicting a procedure in an example implementation in which first and second taskbars are displayed.

FIG. 6 is a flow diagram depicting another procedure in an example implementation in which first and second taskbars are displayed.

FIG. 7 illustrates various components of an example device that can be implemented as any type of computing device as described with reference to FIGS. 1-4 to implement embodiments of the techniques described herein.

### DETAILED DESCRIPTION

Overview

Users often employ a plurality of display devices when interacting with a single computing device in order to increase an amount of display area that is available to display data to the users. However, traditional display environments were often designed with a single display device in mind. Therefore, even though the display environment could be expanded across a plurality of display devices, this expansion could hinder interaction supported by the traditional display environment. For example, some traditional display environments included a single taskbar that was accessible on a single one of the display devices. Therefore, interaction with this taskbar may become cumbersome, which may involve crossing boundaries of multiple display devices to interact with the taskbar (e.g., to switch windows), may lower a user's ability to locate a desired application, and so on.

A display environment for a plurality of display devices is described. In one or more implementations, a display environment is configured to support multiple taskbars. For example, a primary taskbar may be configured for display on primary display device of a computing device. The primary taskbar may include representations (e.g., icons, tiles, and so on) of each application that is being executed on the computing device.

Secondary taskbars may also be configured for display on secondary display devices of the display environment. In one or more instances, each secondary taskbar is configured to include representations of applications that correspond to windows for display on a corresponding display device, solely. Thus, a user may interact with a primary taskbar to select from representations of each application that is being executed on the computing device. The user may also interact with secondary taskbars displayed on corresponding secondary display devices to access representations of applications that correspond to that device, e.g., correspond to windows that are to be displayed on that device. A variety of other examples are also contemplated, further discussion of which may be found in relation to the following figures.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

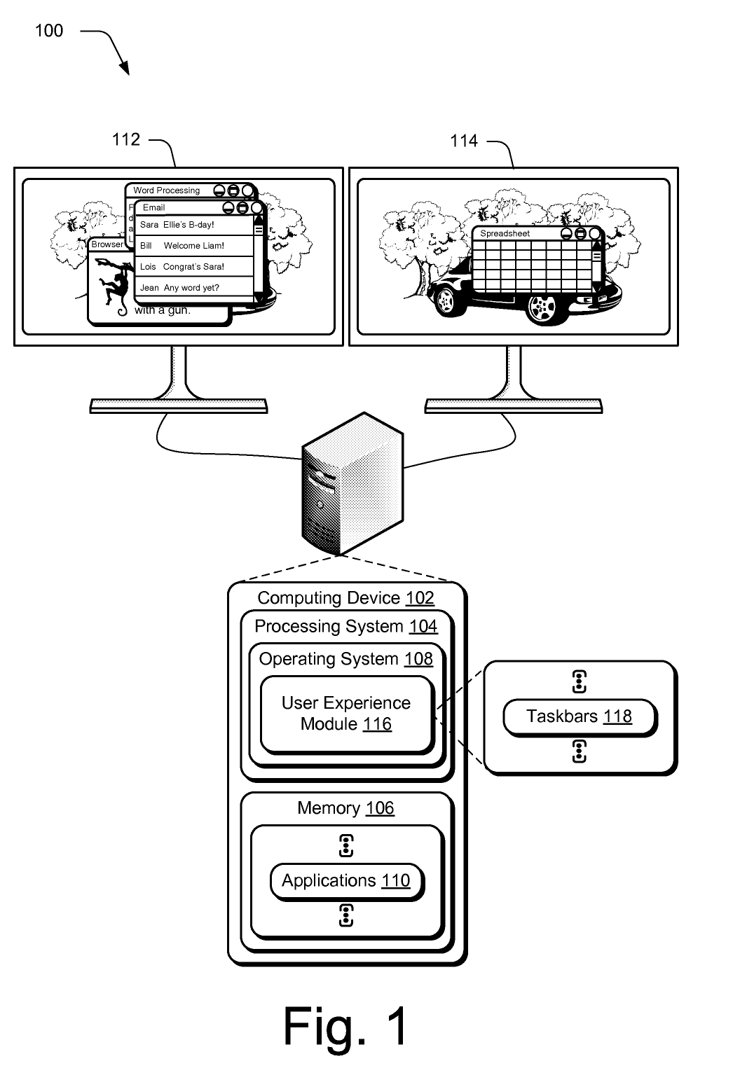

FIG. 1 is an illustration of an environment 100 in an example implementation that is operable to employ the display environment techniques described herein. The illustrated environment 100 includes a computing device 102 having a processing system 104 and a computer-readable storage medium that is illustrated as a memory 106 although other confirmations are also contemplated as further described below.

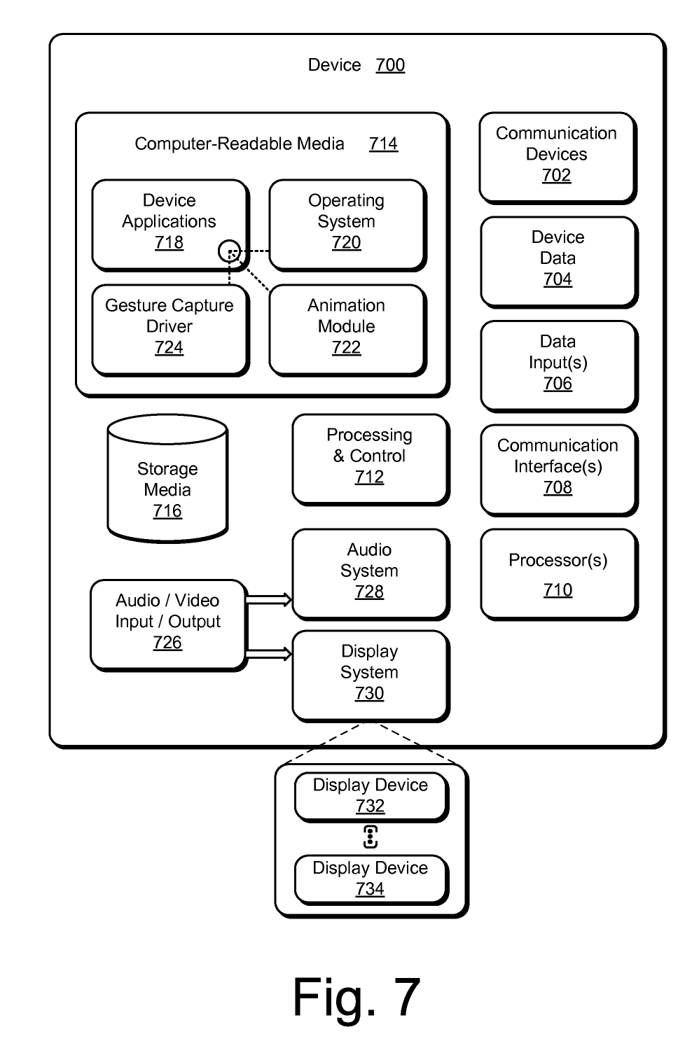

The computing device 102 may be configured in a variety of ways. For example, a computing device may be configured as a computer that is capable of communicating over a network, such as a desktop computer, a mobile station, an entertainment appliance, a set-top box communicatively coupled to a display device, a wireless phone, a game console, and so forth. Thus, the computing device 102 may range from full resource devices with substantial memory and processor resources (e.g., personal computers, game consoles) to a low-resource device with limited memory and/or processing resources (e.g., traditional set-top boxes, hand-held game consoles). An additional example of a computing device 102 may be found discussed in relation to FIG. 7.

The computing device 102 is further illustrated as including an operating system 108. The operating system 108 is configured to abstract underlying functionality of the computing device 102 to applications 110 that are executable on the computing device 102. For example, the operating system 108 may abstract the processing system 104, memory 106, display devices 112, 114, network, and other functionality of the computing device 102 such that the applications 110 may be written without knowing “how” this underlying functionality is implemented. The application 110, for instance, may provide data to the operating system 108 to be rendered and displayed by the display devices 112, 114 without understanding how this rendering will be performed. The operating system 108 may also represent a variety of other functionality, such as to manage a file system and user interface that is navigable by a user of the computing device 102.

The operating system 108 is also illustrated as including a user experience module 116 which is representative of functionality of the computing device 102 to manage user interfaces displayed by the display devices 112, 114. For example, the user experience module 116 may be utilized to abstract functionality of the computing device 102 as described above to manage how data is displayed by the computing device 102.

For example, the user experience module 116 may be configured to manage display of windows that correspond to applications that are executed on the computing device. Examples of such windows as illustrated include word processing, email, and browser windows that are displayed on display device 112. A spreadsheet window is illustrated as being displayed on the other display device 114.

The user experience module 116 may thus support interaction with the applications 110 without requiring the application 110 to manage a corresponding window frame's layout, primacy of the window with respect to other windows (e.g., whether a window is active, in front of behind other windows), an order of the windows, and so on.

Thus, the user experience module 116 may be configured to present applications and corresponding data through windows having frames. These frames may provide controls through which a user may interact with an application as well as controls enabling a user to move and size the window. The user experience module 116 may also support techniques to navigate through a hierarchical file structure through the use of folders and represent the data and applications through use of icons. Although illustrated as part of the operating system 108, the user experience module 116 may be implemented in a variety of other ways, such as a stand-alone module, remotely via a network, and so forth.

The user experience module 116 may also be configured to implement taskbars 118 for display on the display devices 112, 114. These taskbars 118 may be configured in a variety of ways to support a variety of different interactions. For example, each of the taskbars 118 may be configured for display on each of the display devices 112, 114 of the computing device 102. In this example, each taskbar 118 may be configured to include a representation of each application 110 that is being executed on the computing device 102, e.g., is loaded into volatile memory of the computing device for interaction with a user. The representations may thus be used to apply focus to a represented application such that a user may interact with the application 110, e.g., a window of the application.

In another example, each of the taskbars 118 may be configured to include representations of applications 110 that display user interfaces on the device. For instance, a taskbar displayed on the display device 112 may include representations of applications having windows that are displayed and/or are to be displayed (e.g., hidden) on that device. Examples of such representations in this example may include representations of the email, word processing, and browser applications as illustrated for display device 112. Likewise, a taskbar 118 to be displayed on display device 114 may include a representation of the spreadsheet application. However, taskbar 118 displayed on display device 114 would not include representations of the email, word processing, or browser applications in this example. Likewise, a taskbar 118 displayed on display device 112 in this example would not include a representation of the spreadsheet application. Thus, in this example the taskbars 118 are configured for the applications that support interaction via the specific display devices.

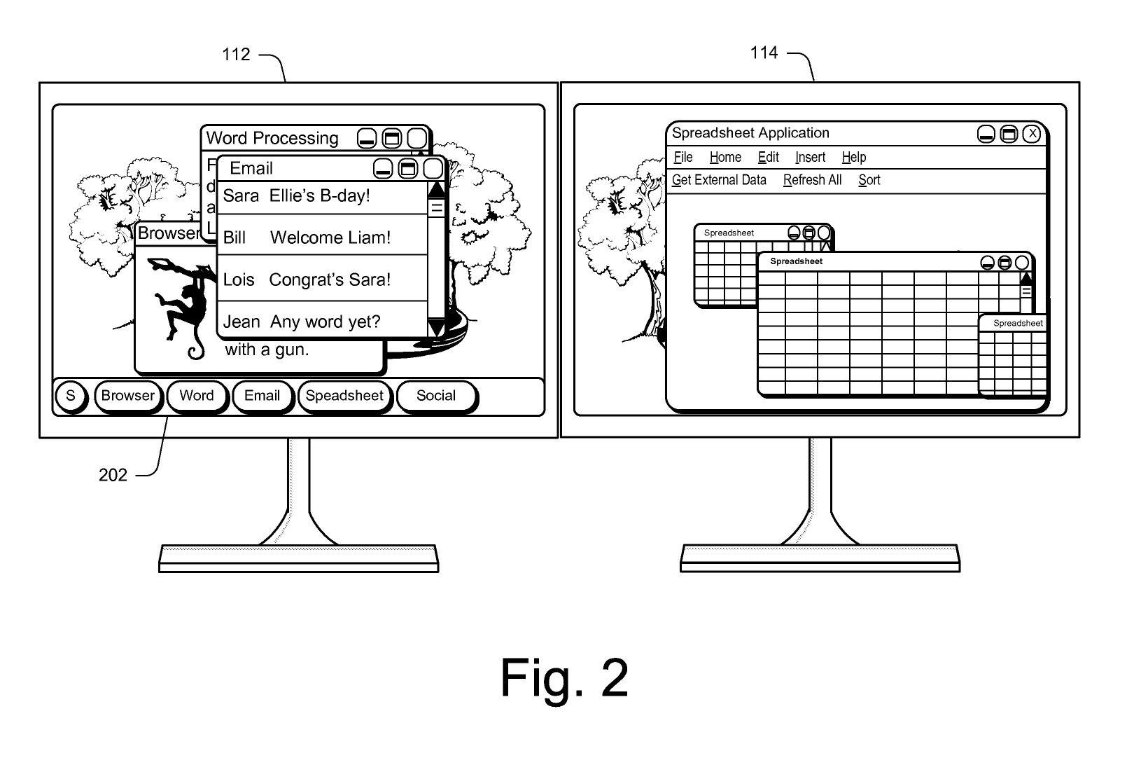

In a further example, the taskbars 118 may be configured to support different functionality, respectively. For example, a first taskbar may be configured to include representations of each of the applications 110 that are being executed on the computing device 102, e.g., are available for current execution such as by being loaded into RAM. A second taskbar that is displayed on another display device 114, however, may be configured to include representations of applications 110 that correspond to that display device, e.g., have windows that are to be displayed primarily on that device. In this way, a user may have access to each of the applications on the first taskbar and specific applications on a second taskbar. This example display environment is further illustrated in relation to FIG. 2.

Generally, any of the functions described herein can be implemented using software, firmware, hardware (e.g., fixed logic circuitry), or a combination of these implementations. The terms “module,” “functionality,” and “engine” as used herein generally represent software, firmware, hardware, or a combination thereof. In the case of a software implementation, the module, functionality, or engine represents program code that performs specified tasks when executed on a processor (e.g., CPU or CPUs). The program code can be stored in one or more computer readable memory devices. The features of the display environment techniques described below are platform-independent, meaning that the techniques may be implemented on a variety of commercial computing platforms having a variety of processors.

For example, the computing device 102 may also include an entity (e.g., software) that causes hardware of the computing device 102 to perform operations, e.g., processors, functional blocks, and so on. For example, the computing device 102 may include a computer-readable medium that may be configured to maintain instructions that cause the computing device, and more particularly hardware of the computing device 102 to perform operations. Thus, the instructions function to configure the hardware to perform the operations and in this way result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

FIG. 2 is an illustration of a system 200 in an example implementation of a computing device of FIG. 1 as employing a plurality of display devices and a primary taskbar. In this example, a primary taskbar 202 is illustrated as being displayed on display device 112. In one or more implementations, the display device 112 is further configured as a primary display device by the operating system 108 and thus the primary taskbar 202 is configured for display on this display device 112, accordingly, by the user experience module 116.

The primary taskbar 202 is illustrated as including a representation of a start menu, which is illustrated as a circle with an “S.” The primary taskbar 202 is also illustrated as including representations of applications 108 that have user interfaces that are available for output on the computing device 102, e.g., are being executed on the computing device 102. The taskbars may also include representations of applications that are not currently executed, such as pinned icons.

As illustrated, the primary taskbar 202 includes representations of a browser, word processing application, email, spreadsheet application, and a social network application. As shown, windows corresponding to the browser, word processing application, and email application are displayed on display device 112. A window corresponding to the spreadsheet application is displayed on display device 114. In this example, a window corresponding to the social network application is minimized but is available for output on display device 114. Thus, the social network application is still represented in the primary taskbar 202. The display environment may also support a secondary taskbar for display on display device 114 as described in relation to the following figure.

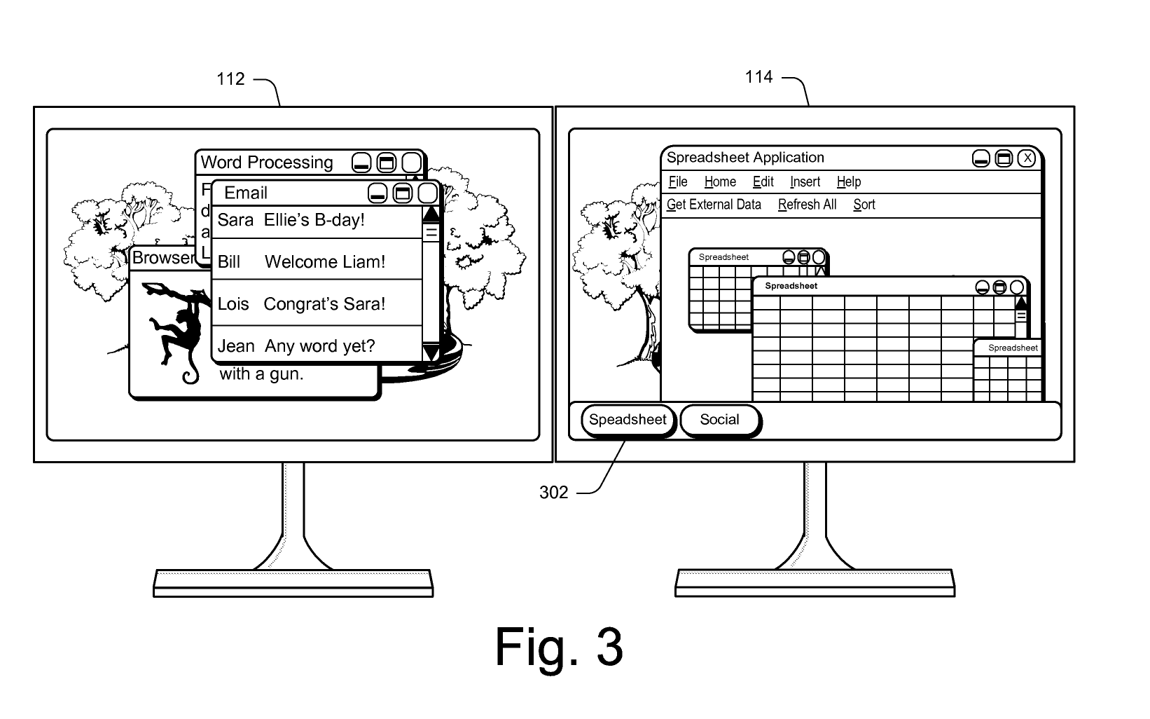

FIG. 3 is an illustration of a system 300 in an example implementation of a computing device of FIG. 1 as employing a plurality of display devices and a secondary taskbar. In this example, the secondary taskbar 302 is illustrated as being displayed on display device 114. Following the previous example, the display device 112 is further configured as a primary display device by the operating system 108 and thus display device 114 is configured as a secondary display device.

The secondary taskbar 302 in the illustrated example is configured to include representations of applications that correspond to the display device on which the taskbar is to be displayed. As described previously, a spreadsheet application is illustrated as displaying a user interface (e.g., a window) that corresponds to the application on display device 114. Accordingly, a representation of the spreadsheet application is included in the secondary taskbar 302.

A representation of a social network application is also illustrated as being included in the secondary taskbar 302. Thus, even though a user interface that corresponds to the spreadsheet application is not currently being displayed (e.g., it may be minimized, obscured by a window of the spreadsheet application, and so on), the representation is still included in the taskbar. In other words, since display of the user interface of the social network application would occur on the display device 114 the representation of that application is included in the secondary taskbar 302 to be made accessible via that taskbar.

In one or more implementations, logic may be employed to “choose” a taskbar that is to include the representation in an instance in which the user interface of an application spans more than one display device. For example, the logic of the user experience module 116 may determine which display device is associated with a majority of a display area of the user interface (e.g., window) and assign the representation to a taskbar in that display device. In another example, the user experience module 116 may base this selection on which display device includes a primary portion (e.g., left edge, control bars, chrome, title, and so on) of the user interface and assign the representation accordingly. In a further example, each taskbar associated with a display device that includes a portion of the user interface may include a representation. A variety of other examples are also contemplated.

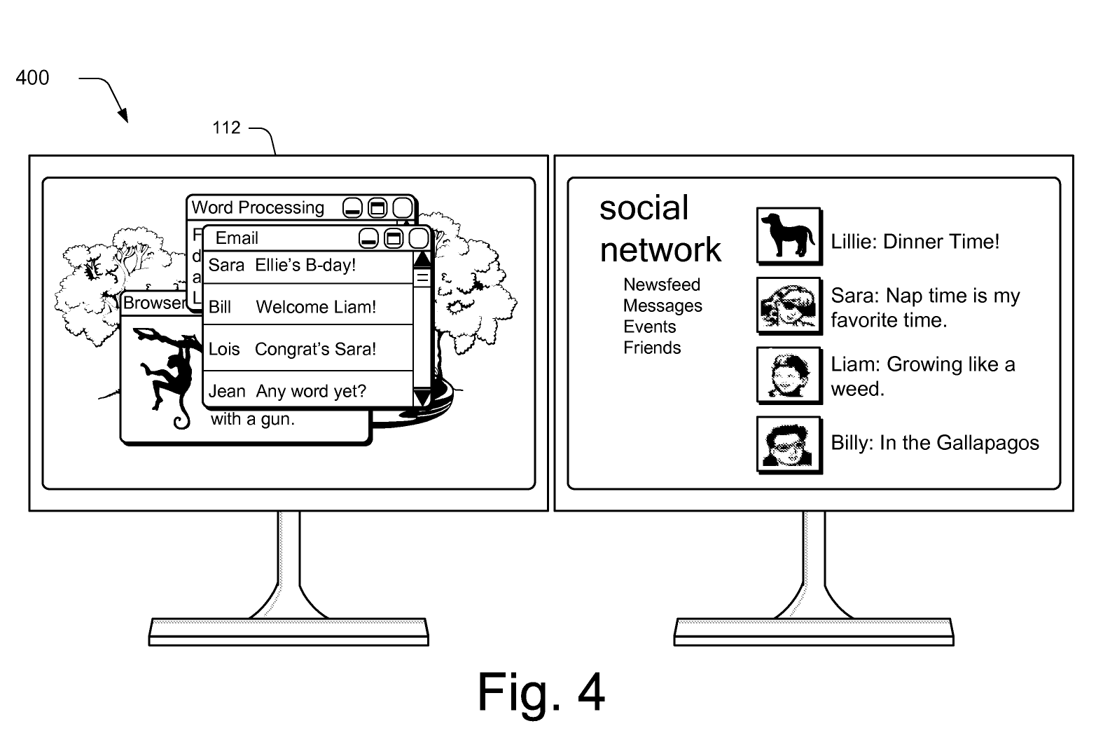

Thus, the representation may be selected to give focus to the represented application, such as to cause display of the corresponding user interface in a manner via which a user may interact, e.g., provide inputs to the application. A result of selection of the representation of the social network application is illustrated in relation to an example system 400 of FIG. 4.

Taskbars may be configured to include a wide variety of functionality. For example, as describe previously the taskbar may include a control that is selectable to launch a start menu such that a user may initiate execution of represented applications 110. The start menu may also include access to other functionality of the operating system 108, such as control panel, navigate through a file structure, restarting or shutting down the computing device 102, and so on. The taskbars 118 may also support window preview through hovering a cursor above a representation of an application to preview a window of that application. The taskbars 118 may further support a view of related files of the application, such as a right-click of a cursor control device to view recent files accessed via the represented application 110. A variety of other examples are also contemplated. Further discussion of configuration of taskbars for use by multiple display devices of a computing device may be found in relation to the following procedures.

Example Procedures

The following discussion describes display environment techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the systems 200-400 of FIGS. 2-4, respectively.

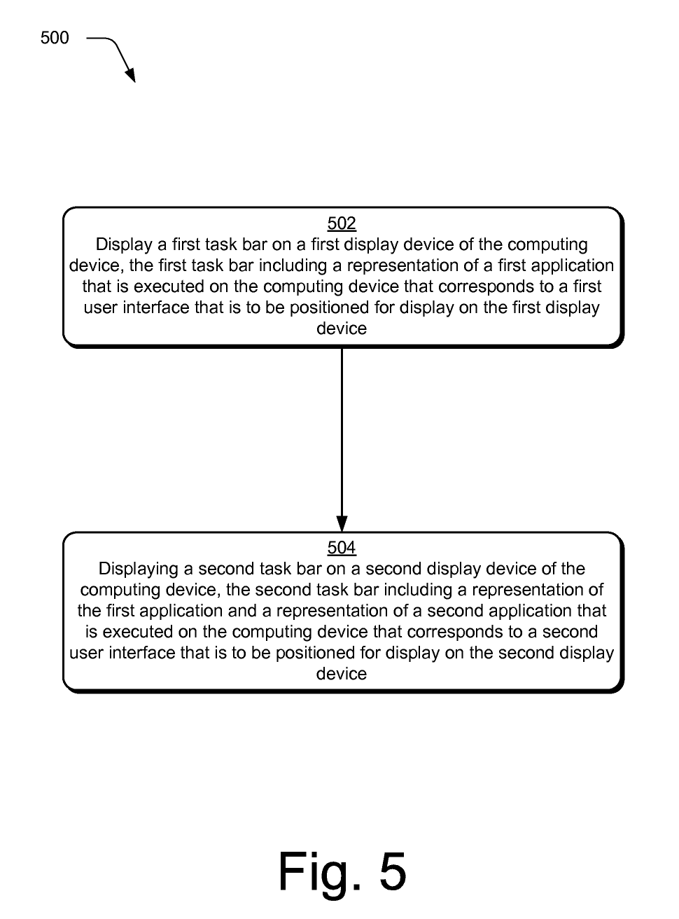

FIG. 5 depicts a procedure 500 in an example implementation in which first and second taskbars are displayed. A first taskbar is displayed on a first display device of a computing device, the first taskbar including a representation of a first application that is executed on the computing device that corresponds to a first user interface that is to be positioned for display on the first display device (block 502). As shown in FIG. 3, for instance, a window for a spreadsheet application is displayed on display device 114. Therefore, a representation of the spreadsheet application is included in the taskbar 302 displayed on display device 114.

A second taskbar is displayed on a second display device of the computing device, the second taskbar including a representation of the first application and a representation of a second application that is executed on the computing device that corresponds to a second user interface that is to be positioned for display on the second display device (block 504). Continuing with the previous example, as shown in FIG. 2, a window of an email application is displayed on display device 112. Therefore, a representation of the email application is included in the taskbar 202 displayed on that display device. In this instance, taskbar 202 is configured as a primary taskbar. Consequently, the taskbar 202 is also configured to include representations of applications that correspond to other display devices, such as the spreadsheet application described above. Thus, the taskbar 202 may include representations of applications that correspond to the display device on which it is displayed as well as other display devices, whereas taskbar 302 includes representations of applications that correspond to that display device, solely. Another example of a taskbar is described in relation to the following figure.

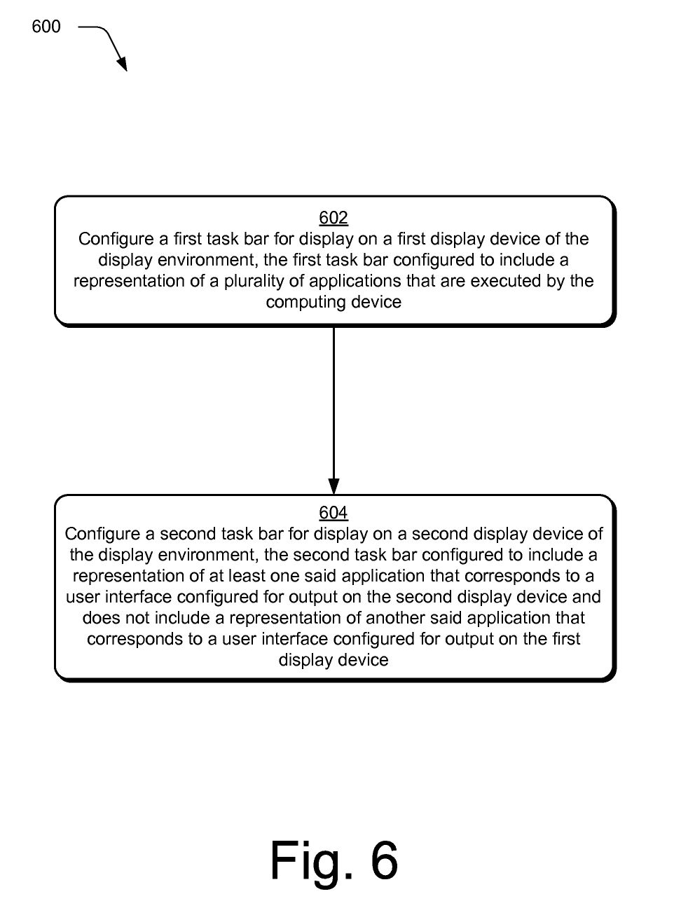

FIG. 6 depicts another procedure 600 in an example implementation in which first and second taskbars are displayed. A display environment of a computing device is configured to display a first taskbar for display on a first display device of the display environment, the first taskbar configured to include a representation of a plurality of applications that are executed by the computing device (block 602). As before, taskbar 202 of FIG. 2 may include representations of applications that are executed by the computing device 102, e.g., loaded into RAM or other volatile memory.

A second taskbar is configured for display on a second display device of the display environment, the second taskbar configured to include a representation of at least one application that corresponds to a user interface configured for output on the second display device and does not include a representation of another application that corresponds to a user interface configured for output on the first display device (block 604). Again, taskbar 302 may be configured to include representations of applications that correspond to display device 114 but does not include representations of applications that correspond to other display devices, e.g., the email, word processing, or browser applications that correspond to display device 112. A variety of other examples are also contemplated without departing from the spirit and scope thereof.

Example Device

FIG. 7 illustrates various components of an example device 700 that can be implemented as any type of computing device as described with reference to FIGS. 1-4 to implement embodiments of the display environment techniques described herein. Device 700 includes communication devices 702 that enable wired and/or wireless communication of device data 704 (e.g., received data, data that is being received, data scheduled for broadcast, data packets of the data, etc.). The device data 704 or other device content can include configuration settings of the device, media content stored on the device, and/or information associated with a user of the device. Media content stored on device 700 can include any type of audio, video, and/or image data. Device 700 includes one or more data inputs 706 via which any type of data, media content, and/or inputs can be received, such as user-selectable inputs, messages, music, television media content, recorded video content, and any other type of audio, video, and/or image data received from any content and/or data source.

Device 700 also includes communication interfaces 708 that can be implemented as any one or more of a serial and/or parallel interface, a wireless interface, any type of network interface, a modem, and as any other type of communication interface. The communication interfaces 708 provide a connection and/or communication links between device 700 and a communication network by which other electronic, computing, and communication devices communicate data with device 700.

Device 700 includes one or more processors 710 (e.g., any of microprocessors, controllers, and the like) which process various computer-executable instructions to control the operation of device 700 and to implement embodiments of the techniques described herein. Alternatively or in addition, device 700 can be implemented with any one or combination of hardware, firmware, or fixed logic circuitry that is implemented in connection with processing and control circuits which are generally identified at 712. Although not shown, device 700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 700 also includes computer-readable media 714, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 700 can also include a mass storage media device 716.

Computer-readable media 714 provides data storage mechanisms to store the device data 704, as well as various device applications 718 and any other types of information and/or data related to operational aspects of device 700. For example, an operating system 720 can be maintained as a computer application with the computer-readable media 714 and executed on processors 710. The device applications 718 can include a device manager (e.g., a control application, software application, signal processing and control module, code that is native to a particular device, a hardware abstraction layer for a particular device, etc.). The device applications 718 also include any system components or modules to implement embodiments of the techniques described herein. In this example, the device applications 718 include an interface application 722 and an input/output module 724 that are shown as software modules and/or computer applications. The input/output module 724 is representative of software that is used to provide an interface with a device configured to capture inputs, such as a touchscreen, track pad, camera, microphone, and so on. Alternatively or in addition, the interface application 722 and the input/output module 724 can be implemented as hardware, software, firmware, or any combination thereof Additionally, the input/output module 724 may be configured to support multiple input devices, such as separate devices to capture visual and audio inputs, respectively.

Device 700 also includes an audio and/or video input-output system 726 that provides audio data to an audio system 728 and/or provides video data to a display system 730, which may include a plurality of display device 732, 734. The audio system 728 and/or the display system 730 can include any devices that process, display, and/or otherwise render audio, video, and image data. Video signals and audio signals can be communicated from device 700 to an audio device and/or to a display device via an RF (radio frequency) link, S-video link, composite video link, component video link, DVI (digital video interface), analog audio connection, or other similar communication link. In an embodiment, the audio system 728 and/or the display system 730 are implemented as external components to device 700. Alternatively, the audio system 728 and/or the display system 730 are implemented as integrated components of example device 700.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A system comprising at least one or more modules implemented at least partially in hardware, the one or more modules operable to configure a display environment of a computing device to display to support:
a first taskbar for display on a first display device of the display environment, the first taskbar configured to include a representation of a plurality of applications that are executed by the computing device; and
a second taskbar for display on a second display device of the display environment, the second taskbar configured to include a representation of at least one said application that corresponds to a user interface configured for output on the second display device and does not include a representation of another said application that corresponds to a user interface configured for output on the first display device.

2. A system as described in claim 1, wherein the first display device is specified as a primary display device of the display environment.

3. A system as described in claim 1, wherein each said representation is selectable to apply focus to a respective said application or launch a respective said application.

4. A system as described in claim 1, wherein:
the user interface of the at least one said application is configured for output on the second display device via a window; and
the user interface of the other said application is configured for output on the first display device via another window.

5. A system as described in claim 4, wherein:
the user interface of the at least one said application is configured for output on the second display device via the window such that a majority of the window, when displayed, is displayed by the second display device; and
the user interface of the other said application is configured for output on the first display device via the other window such that a majority of the other window, when displayed, is displayed by the first display device.

6. A system as described in claim 1, wherein at least one of the user interface configured for output on the second display device or the user interface configured for output on the first display device is hidden from display.

7. A system as described in claim 1, wherein the one or more modules are part of an operating system of the computing device.

8. A method implemented by a computing device, the method comprising:
displaying a first taskbar on a first display device of the computing device, the first taskbar including a representation of a first application that is executed on the computing device that corresponds to a first user interface that is to be positioned for display on the first display device; and
displaying a second taskbar on a second display device of the computing device, the second taskbar including a representation of the first application and a representation of a second application that is executed on the computing device that corresponds to a second user interface that is to be positioned for display on the second display device.

9. A method as described in claim 8, wherein the second display device is specified as a primary display device of the display environment.

10. A method as described in claim 8, wherein each said representation is selectable to apply focus to a respective said application.

11. A method as described in claim 8, wherein the second taskbar does not include a representation that is configured for inclusion in the first taskbar.

12. A method as described in claim 8, wherein:
the second user interface of the second application is configured for output on the second display device via a second window; and
the first user interface of the first application is configured for output on the first display device via a first window.

13. A method as described in claim 11, wherein:
the second user interface of the second application is configured for output on the second display device via the second window such that a majority of the second window, when displayed, is displayed by the second display device; and
the first user interface of the first application is configured for output on the first display device via the first window such that a majority of the first window, when displayed, is displayed by the first display device.

14. A method as described in claim 8, wherein at least one of the first user interface or second user interface is hidden from display.

15. A method as described in claim 8, further comprising saving setting for the second taskbar as corresponding to the second display device such that the settings are used to reconstruct the second taskbar upon reconnection to the computing device.

16. One or more computer readable storage media comprising instructions stored thereon that, in response to execution by a computing device, causes the computing device to configure a display environment of an operating system executed by the computing device to include:
a primary taskbar for display on a primary display device of the display environment, the primary taskbar configured to include a representation of each application that is being executed by the computing device; and
a secondary taskbar for display on a secondary display device of the display environment, the secondary taskbar configured to include a representation for each said application that is executed on the computing device having a corresponding window that is positioned for display on the secondary display device.

17. One or more computer readable storage media as described in claim 16, wherein the secondary taskbar does not include a representation that is included in the primary taskbar.

18. One or more computer readable storage media as described in claim 16, wherein the primary taskbar includes each representation that is to be included in the secondary taskbar.

19. One or more computer readable storage media as described in claim 16, wherein the secondary taskbar does not include a representation of an application that is being executed by the computing device having a corresponding window that is positioned for display on the primary display device.

20. One or more computer readable storage media as described in claim 16, wherein each said representation is selectable to apply focus to a respective said application.
